(19) United States
(12) Patent Application Publication
(10) Pub. No.: US 2021/0244030 A1
(43) Pub. Date: Aug. 12, 2021

(54) TRANSITION METAL ORGANIC FRAMEWORK HAVING ANTIBACTERIAL PROPERTIES

(71) Applicant: LG Electronics Inc., Seoul (KR)

(72) Inventors: Jihyun KIM, Seoul (KR); Sanghyun HONG, Seoul (KR); Seojin LEE, Seoul (KR)

(21) Appl. No.: 17/049,776

(22) PCT Filed: May 2, 2019
(86) PCT No.: PCT/KR2019/005265

§ 371 Date: Oct. 22, 2020

Related U.S. Application Data
(60) Provisional application No. 62/668,266, filed on May 8, 2018.

(30) Foreign Application Priority Data
Mar. 26, 2019 (KR) 10-2019-0034541

(51) Int. Cl. A01N 59/20; A01N 59/16; A01N 25/10; A01N 25/34; C07F 11/00; C07F 5/00; C07F 7/28; C07F 7/22; C07F 7/02; C07F 7/00; C07F 13/00; C07F 1/00; C07F 1/08; C07F 5/06; C07F 9/00; C09D 171/02; C09D 133/08; C09D 129/04; C09D 7/63; C09D 5/14; C08K 3/22; C08K 5/32; C08K 5/09

(52) U.S. Cl. CPC A01N 59/20; C08K 2003/2296; A01N 25/10; A01N 25/34; C07F 11/005; C07F 5/003; C07F 7/28; C07F 7/2224; C07F 7/025; C07F 7/003; C07F 13/005; C07F 1/005; C07F 1/08; C07F 5/069; C07F 9/005; C09D 171/02; C09D 133/08; C09D 129/04; C09D 7/63; C09D 5/14; C08K 3/22; C08K 5/32; C08K 5/09; C08K 2003/2255; A01N 59/16

(57) ABSTRACT

The present invention relates to a transition metal organic framework, comprising: a transition metal oxide having antibacterial or antifungal properties; and an organic compound having at least one hydrophilic functional group, wherein the organic compound is bound to the transition metal oxide to surround the transition metal oxide and the hydrophilic functional group is placed toward the outside of the transition metal organic framework.

### CROSS-REFERENCE TO RELATED APPLICATIONS

This application is the National Stage filing under 35 U.S.C. 371 of International Application No. PCT/KR2019/005265, filed on May 2, 2019, which claims the benefit of earlier filing date and right of priority to U.S. Provisional Application No. 62/668,266 filed on May 8, 2018 and Korean Application 10-2019-0034541 filed on Mar. 26, 2019, the contents of which are all hereby incorporated by reference herein in their entirety.

### TECHNICAL FIELD

The present disclosure relates to transition metal organic frameworks (t-MOFs) having antibacterial properties, and more particularly, to transition metal organic frameworks configured to prevent generation of odor-causing substances.

### BACKGROUND ART

Microorganisms such as bacteria and fungi exist around life. Particularly, bacteria and fungi may actively propagate on surfaces exposed to a high-moisture environment. Due to the propagation of the bacteria and fungi on the surfaces, substances that cause unpleasant odors are produced.

To solve this problem, moisture may be removed immediately to prevent the propagation of bacteria and fungi or molds. However, there may be many difficulties in creating an environment from which moisture has been removed. For example, it may be difficult to remove moisture such as condensate that is formed on a surface of a heat exchanger during an operation of the heat exchanger as a key component of an air conditioner, a refrigerator, a laundry dryer, and the like. In addition, there are also surfaces, for example, a washing machine and the like that are constantly exposed to moisture and thus difficult to avoid a humid environment.

Accordingly, in order to remove unpleasant odors generated by the bacteria and fungi, a masking technique is used for hiding unpleasant odors by mixing fragrant substances. However, mixing different scents requires continuous input of fragrant substances, and individuals' feelings about the fragrant substances are subjective. This may limit the effect that can be obtained through the masking technique. In addition, the masking technique has a disadvantage in that it cannot fundamentally remove unpleasant odors.

Therefore, antibacterial and catalytic properties may be imparted to a base material by putting transition metal oxides into the base material. Transition metal oxides have antibacterial properties of inhibiting the growth of bacteria and destroying the bacteria by quickly changing the surface of the base material to be acidic when contacting moisture in the atmosphere. Such transition metal oxides also have catalytic properties of adsorbing and oxidizing some odorous substances to change them into odorless compounds.

When the transition metal oxides are used to impart antibacterial and catalytic properties to the base material, the transition metal oxides must be in the form of particles having a relatively large surface area in order to maintain the properties of materials such as polymers and the like forming a coating layer. An example of such particles may be microparticles of several micrometers to hundreds of nanometers.

In the prior art literature, European Laid-open Patent Publication No. 3,082,415 A1 (Oct. 26, 2016), as an example of a transition metal oxide, a composite material composed of an inorganic compound containing molybdenum was coated on a surface of a product to inhibit the growth of bacteria and molds. That is, the generation of unpleasant odors due to the bacteria and fungi was prevented by the antibacterial effect of the composite material composed of the inorganic compound containing molybdenum.

However, there was a limit to forming a base material containing the inorganic compound due to very low water solubility of the inorganic compound containing molybdenum as disclosed in the prior art literature. That is, the prior art inorganic compound containing molybdenum having the antibacterial properties was present in the form of a suspension or dispersion that is dispersed in a water-soluble coating material. As a result, the coating material containing the inorganic compound had a problem in that it was precipitated over time or was not uniformly coated on the base material due to being entangled. Therefore, the present disclosure proposes transition metal organic frameworks capable of being uniformly coated on a base material while containing the inorganic compound.

### DISCLOSURE

### Technical Problem

One aspect of the present disclosure is to provide transition metal organic frameworks capable of being uniformly distributed on a surface of a base material that requires for antibacterial or antifungal properties.

Another aspect of the present disclosure is to provide a variety of materials having antibacterial or antifungal properties by being uniformly coated with the transition metal organic frameworks.

### Technical Solution

A transition metal organic framework having antibacterial or antifungal properties according to the present disclosure may include a transition metal oxide, and an organic compound bound to the transition metal oxide. An organic compound containing a hydrophilic functional group may be bound to a transition metal oxide, such that transition metal organic frameworks can be uniformly distributed in a base material containing hydrophilic polymers. Thus, moisture may be supplied to the transition metal organic frameworks to form acidic substances or active oxygen. This may result in reducing odors and imparting antibacterial or antifungal properties to the base material.

In addition, the transition metal organic framework according to the present disclosure may be included in a coating layer of a product requiring antibacterial or antifungal properties, a fiber of a filter requiring the antibacterial or antifungal properties, or an injection-molded component constituting a product requiring the antibacterial or antifungal properties, which may result in providing various materials with improved antibacterial or antifungal properties.

Specifically, the transition metal organic framework may include a transition metal oxide having antibacterial or antifungal properties, and an organic compound bound to the transition metal oxide. The organic compound may form a coordinate covalent bond to the transition metal oxide to surround the transition metal oxide. The organic compound may include ligands forming the coordinate covalent bond with the transition metal oxide, and organic brushes placed at ends of the ligands. The organic brushes each may contain a hydrophilic functional group, and the hydrophilic functional group may be disposed toward outside of the transition metal organic framework.

In an implementation, a metal of the transition metal oxide may include at least one selected from the group consisting of W, Mo, La, Ti, Si, Zr, Re, Hf, Ag, Cu, Sn, Nb, Al, and Va.

In an implementation, the hydrophilic functional group of the organic brush may include at least one of a carboxyl group (R—COOH), a ketone group (R—CO—R) or an amine group (R—NH₂, R₂—NH, R₃—N, (R—N═R).

In an implementation, the organic brush may include cyclic hydrocarbon.

In an implementation, the organic brush may contain at least one selected from a group consisting of the following structures.

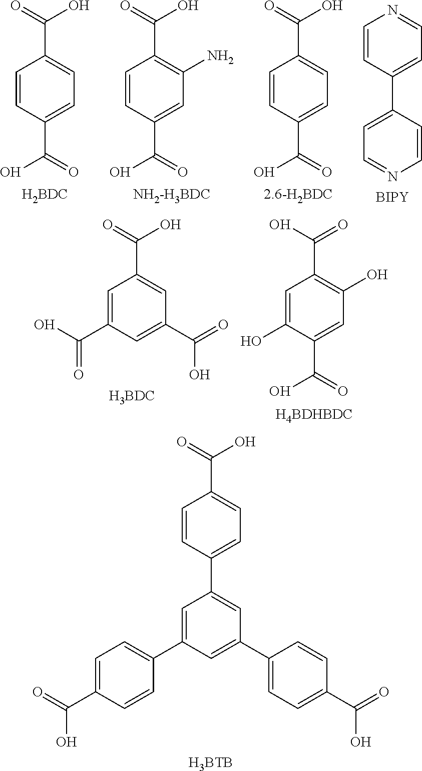

In an embodiment, a content of the transition metal oxide may be 0.1 to 5 wt % of the transition metal organic framework.

In an implementation, an average size of the transition metal organic frameworks may be 20 to 700 nm.

The present disclosure discloses a hydrophilic coating layer containing the aforementioned transition metal organic frameworks.

In an implementation, the hydrophilic coating layer may include at least one selected from a group consisting of polyvinyl alcohol, polyoxyethylene glycol, polysulfonic acid, polyacrylic acid, polymethacrylic acid, and polypropylene glycol.

In an implementation, an average thickness of the hydrophilic coating layers may be 700 to 2000 nm.

In an implementation, a content of the transition metal organic frameworks may be 1 to 5 wt % of the hydrophilic coating layer.

The present disclosure also discloses a fiber including the aforementioned transition metal organic frameworks.

Furthermore, the present disclosure discloses an injection-molded product including the aforementioned transition metal organic frameworks.

### Advantageous Effects

In transition metal organic frameworks according to the present disclosure, an organic compound including a hydrophilic functional group having an affinity with a water-soluble hydrophilic polymer, which is used to form a coating layer of a base material, may be bound to a transition metal oxide, such that the transition metal organic frameworks can be uniformly distributed in the coating layer of the base material. Thus, moisture may be supplied to the transition metal organic frameworks to form acidic substances or active oxygen. This may result in reducing odors and imparting antibacterial or antifungal properties to the base material.

In addition, the transition metal organic frameworks according to the present disclosure may be included in a coating layer of a product requiring antibacterial or antifungal properties, a fiber of a filter requiring the antibacterial or antifungal properties, or an injection-molded component constituting a product requiring the antibacterial or antifungal properties, which may result in providing various materials with improved antibacterial or antifungal properties.

Specifically, the transition metal organic frameworks according to the present disclosure may be realized such that the organic compound is bound to the transition metal oxide to form a strong bond to the water-soluble hydrophilic polymer contained in the coating layer of the base material. Thus, the transition metal organic frameworks may not be eluted from the coating layer. This may allow the base material to continuously maintain the antibacterial or antifungal properties.

In addition, the organic compound may form the bond to the transition metal oxide in the transition metal organic frameworks. Accordingly, the transition metal organic frameworks can have improved dispersibility and uniformly distributed in the base material without aggregation.

In addition, the transition metal organic frameworks according to the present disclosure may easily adjusted in size so as to have various average sizes depending on use, thereby maximizing the antibacterial or anti-fungal properties.

### BRIEF DESCRIPTION OF THE DRAWINGS

FIG. 1 is a conceptual diagram of a transition metal organic framework according to the present disclosure.

FIG. 2 is a conceptual diagram illustrating a hydrophilic coating layer containing transition metal organic frameworks according to the present disclosure.

FIG. 3 is a view showing electron-microscopic images of a hydrophilic coating layer of a comparative example and a hydrophilic coating layer containing transition metal organic frameworks according to one implementation.

FIG. 4 is a conceptual diagram illustrating a fiber containing transition metal organic frameworks according to another implementation.

### MODES FOR CARRYING OUT THE PREFERRED EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

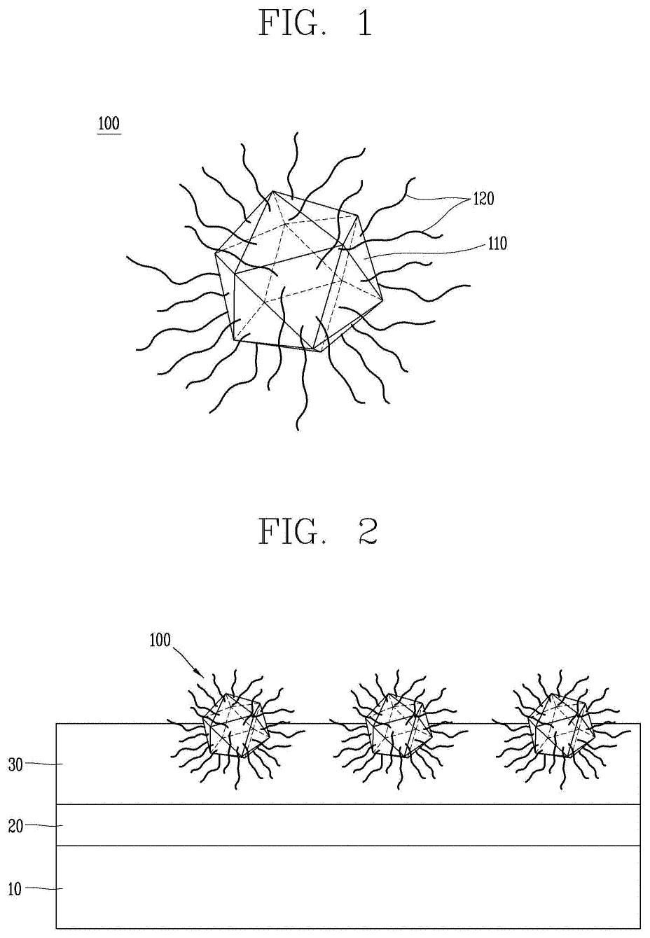

FIG. 1 is a conceptual diagram of a transition metal organic framework 100 according to the present disclosure.

The present disclosure relates to transition metal organic frameworks 100 having antibacterial or antifungal properties.

In one implementation disclosed herein, the transition metal organic frameworks 100 may include transition metal oxides 110 and organic compounds 120. The transition metal oxide 110 may have antibacterial or antifungal properties. In detail, the transition metal oxide 110 may contain at least one selected from a group consisting of W, Mo, La, Ti, Si, Zr, Re, Hf, Ag, Cu, Sn, Nb, Al, and Va.

The transition metal oxide 110 is also a material that reacts with moisture to form active oxygen so as to reduce odors and exhibit antibacterial or antifungal properties. Accordingly, the transition metal oxide 110 may inhibit the generation of bacteria and fungi in a high-moisture environment, thereby suppressing the generation of odor-causing substances such as nitrogen compounds that are produced by metabolism of the bacteria and fungi. In addition, the transition metal oxide 110 may inhibit the growth of the bacteria or fungi or destroy them by changing its surface to be acidic when brought into contact with moisture in the atmosphere.

In one implementation, zinc molybdate (ZnMoO4), which is a kind of transition metal oxide containing molybdenum (Mo), may perform an antibacterial activity, particularly for colon bacillus. In addition, the transition metal oxide containing tungsten (W) has an excellent antibacterial effect against a staphylococcus, and also has excellent antifungal properties.

Therefore, the transition metal organic frameworks 100 of the present disclosure can inhibit the generation of various bacteria or fungi by including the transition metal oxides 110 that include at least one selected from the group consisting of W, Mo, La, Ti, Si, Zr, Re, Hf, Ag, Cu, Sn, Nb, Al, and Va. That is, since the generation of bacteria and fungi is inhibited by the transition metal organic frameworks 100, substances that cause odors produced during a metabolic process of the bacteria and fungi can be suppressed fundamentally.

The organic compounds 120 may contain at least one hydrophilic functional group and may be bound (bonded) to the transition metal oxides 110. In other words, the organic compounds 120 may surround the transition metal oxides 120. The transition metal organic framework 100 may be formed in the manner that the organic compounds 120 surround the transition metal oxide 110. Therefore, the transition metal organic frameworks 100 can exist stably on a surface of or inside a material to which antibacterial or antifungal properties are imparted.

The bonding between the organic compounds 120 and the transition metal oxide 110 may be made by a coordinate covalent bond. That is, the organic compounds 120 may include ligands forming the bond to the transition metal oxide 110. Here, the ligands may not be limited to a specific type if they are molecules or ions having noncovalent electron pairs that may form the coordinate covalent bond with the transition metal oxide 110.

In addition, the aforementioned hydrophilic functional group may be included in an end of the ligand that forms the bond to the transition metal oxide 110. Specifically, the hydrophilic functional group is a compound disposed at the end portion of the ligand, and is referred to as an organic brush in the present disclosure.

In one implementation, the organic compounds 120 may exist in the form in which the organic brushes are formed at the ligands that can facilitate the coordinate covalent bond with the transition metal oxide 110. In other words, the transition metal organic framework 100 may be formed such that the organic compounds 120 surround the transition metal oxide 110 and the ligands of the organic compounds 120 form the bonds to the transition metal oxide 110. On the other hand, the organic compounds 120 may exist in the form that the organic brushes containing the hydrophilic functional group are placed at the ends of the ligands through a covalent bond.

In other words, the organic compound 120 may include a ligand forming a coordinate covalent bond with the transition metal oxide 110, and an organic brush placed at the end of the ligand. Further, the organic brush may contain a hydrophilic functional group, and the hydrophilic functional group may be disposed toward the outside of the transition metal organic framework 100.

Further, the organic brush of the organic compound 120 may also serve as the ligand. Accordingly, the transition metal organic framework 100 may be produced in the form that the organic brushes form the coordinate covalent bond with the transition metal oxide 110.

The organic brushes included in the organic compounds 120 may allow the transition metal oxide 110 to stably exist on the surface of or inside a hydrophilic material to which antibacterial or antifungal properties are imparted.

In addition, the hydrophilic functional group included in the organic brush of the organic compound 120 may be a functional group such as a carboxyl group (R—COOH), a ketone group (R—CO—R) or an amine group (R—NH₂, R₂—NH, R₃—N, (R—N═R). Accordingly, the hydrophilic functional groups on the surface of or inside the hydrophilic material to which the antibacterial or antifungal properties are imparted may form hydrogen bonds to the hydrophilic functional groups of the organic compounds 120. Therefore, the transition metal organic frameworks 100 may stably exist because of strong bonds formed to the surface of or the inside of the material.

In addition, the hydrophilic functional group of the organic brush of the organic compound 120 may be disposed toward the outside of the transition metal organic framework 100. Accordingly, the transition metal organic frameworks 100 may more easily form the hydrogen bonds with the hydrophilic functional groups disposed on the surface of or inside the hydrophilic material to which the antibacterial or antifungal properties are imparted. Therefore, the transition metal organic frameworks 100 may stably exist by forming the hydrogen bonds on the surface of or inside the material.

In addition, the organic brush of the organic compound 120 may include cyclic hydrocarbon. Accordingly, when the organic compounds 120 form the bonds to the transition metal oxide 110, the organic compounds 120 may form a structure constantly surrounding the transition metal oxide 120 due to their own three-dimensionality.

In one implementation, the organic brush of the organic compound 120 may include at least one selected from a group consisting of the following structures.

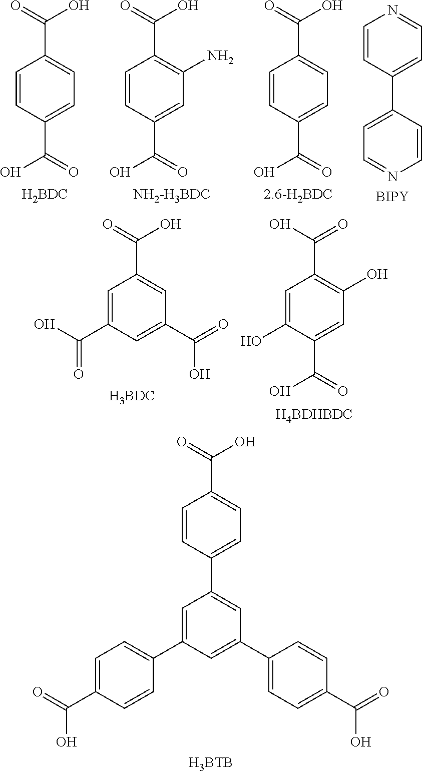

The content of the transition metal oxide 110 in the transition metal organic framework 100 may be 0.1 to 5 wt %. When the content of the transition metal oxide 110 is less than 0.1 wt % of the entire transition metal organic framework 100, the lack of the transition metal oxide 110 causes the transition metal organic framework 100 to have insufficient antibacterial or antifungal properties. In other words, when the content of the transition metal oxide 110 is less than 0.1 wt % of the entire transition metal organic framework 100, active oxygen cannot be formed sufficiently due to the insufficient content of the transition metal oxide 110. This causes a decrease in properties inhibiting the generation of bacteria and fungi.

On the other hand, when the content of the transition metal oxide 110 exceeds 5 wt % of the transition metal organic framework 100, there is a problem that the transition metal oxide 110 and the organic compound 120 do not exist evenly. Specifically, when the total content of the transition metal oxide 110 exceeds 5 wt % of the transition metal organic framework 100, there is a problem that the transition metal oxide 110 is aggregated and separated.

The average size of the transition metal organic frameworks 100 may be 20 to 700 nm. When the average size of the transition metal organic frameworks 100 is less than 20 nm, excessive moisture may adhere to the transition metal organic frameworks 100, which may make natural drainage difficult. If the natural drainage is not performed, bacteria or fungi grow more easily than otherwise, and there is a disadvantage that a large amount of odor-causing substances may be produced.

On the other hand, when the average size of the transition metal organic frameworks 100 exceeds 700 nm, there is a problem that antibacterial or antifungal properties may be deteriorated due to a reduction in the surface areas of the transition metal organic frameworks 100.

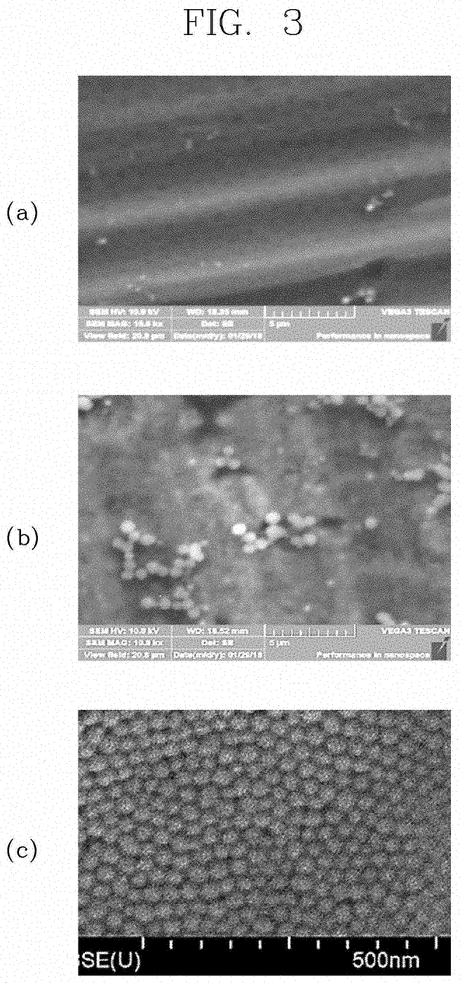

FIG. 2 is a conceptual diagram of a hydrophilic coating layer 30 including the transition metal organic frameworks 100 according to the present disclosure.

The hydrophilic coating layer 30 including the transition metal organic frameworks 100 may be present in the form of being laminated (stacked) on the surface of a base material 10. Further, the hydrophilic coating layer 30 may include the transition metal organic frameworks 100 to react with moisture. Accordingly, odors may be reduced due to active oxygen generated by the transition metal organic frameworks 100, and the antibacterial or antifungal properties may be imparted to the base material 10.

The base material 10 may be a variety of products formed by injection molding. In one implementation, the base material 10 may include a product, such as a heat exchanger that is a key component of an air conditioner, a refrigerator, a laundry dryer or the like, in which odor-causing substances may be generated or present due to being exposed to a high-moisture environment.

In order to stably form the hydrophilic coating layer 30 on the surface of the base material 10, an intermediate layer 20 may be additionally disposed between the base material 10 and the hydrophilic coating layer 30. The intermediate layer 20 may be disposed to improve the adhesion between the base material 10 and the hydrophilic coating layer 30 and may be formed of an organic material capable of forming a hydrogen bond with the hydrophilic coating layer 30. In another implementation, when the base material 10 is formed of aluminum, the intermediate layer 20 may also be a layer including sufficient hydroxyl groups (—OH) by oxidizing the surface of the base material 10.

The hydrophilic coating layer 30 may inhibit the growth of bacteria or fungi and prevent the generation of substances that cause odors. In addition, the odor-causing substances may be removed by the active oxygen that is generated by the reaction between moisture and the transition metal organic frameworks 100. In particular, the hydrophilic coating layer 30 may be applied to products that operate in a humid environment, to generate active oxygen. The active oxygen may decompose the odor-causing substances, thereby removing the odors.

Specifically, microorganisms such as bacteria and fungi may easily propagate by condensed water generated on the surface of the heat exchanger while the heat exchanger operates. Accordingly, odor-causing substances such as nitrogen compounds that are generated by the metabolism of the bacteria and fungi may be removed by the hydrophilic coating layer 30.

The hydrophilic coating layer 30 may also be disposed on a surface, which is difficult to avoid a moisture environment, for example, a washing machine that is continuously exposed to moisture, so as to remove odor-causing substances.

The hydrophilic coating layer 30 may include at least one selected from a group consisting of polyvinyl alcohol, polyoxyethylene glycol, polysulfonic acid, polyacrylic acid, polymethacrylic acid, and polypropylene glycol.

When the hydrophilic coating layer 30 includes polyvinyl alcohol, a vulcanization process to contain sulfur may be performed such that the coating layer can be solid.

The average thickness of the hydrophilic coating layers 30 may be 700 to 2000 nm. When the average thickness of the hydrophilic coating layers 30 is less than 700 nm, the coating layer 30 may not sufficiently include the transition metal organic frameworks 100, and thus substances that cause odors cannot be sufficiently removed. On the other hand, when the average thickness of the hydrophilic coating layers 30 exceeds 2000 nm, the performance of a product may be deteriorated due to the hydrophilic coating layer 30 applied to the surface of the product. For example, in case where the hydrophilic coating layer 30 is disposed on the surface of the heat exchanger, heat-exchange performance may be deteriorated when the average thickness of the hydrophilic coating layers 30 exceeds 2000 nm.

In addition, the total content of the transition metal organic frameworks 100 in the hydrophilic coating layer 30 may be 1 to 5 wt % of the hydrophilic coating layer 30. When the total content of the transition metal organic frameworks 100 is less than 1 wt % of the hydrophilic coating layer 30, the concentration of the transition metal organic frameworks 100 included in the hydrophilic coating layer 30 may be lowered. As a result, substances that cause odors may not be removed effectively. On the other hand, when the total content of the transition metal organic frameworks 100 exceeds 5 wt % of the hydrophilic coating layer 30, separation of the hydrophilic coating layer 30 may be caused and hardness of the hydrophilic coating layer 30 may also be lowered, thereby deteriorating abrasion-resistance and scratch-resistance.

FIG. 3 is a view showing electron-microscopic images of a hydrophilic coating layer of a comparative example and a hydrophilic coating layer containing a transition metal organic framework according to one implementation.

(a) of FIG. 3 shows a comparative example of a hydrophilic coating layer in which only the transition metal oxides are present. In other words, organic compounds bound to the transition metal oxides are excluded from the hydrophilic coating layer of (a) of FIG. 3. Accordingly, it can be seen that the distribution of the transition metal oxides present in the hydrophilic coating layer is lowered.

On the other hand, (b) and (c) of FIG. 3 show that the transition metal organic frameworks are included in the hydrophilic coating layer. In other words, the hydrophilic coating layer shown in (b) and (c) of FIG. 3 includes the transition metal oxides and the organic compounds bound to the transition metal oxides. Further, the organic compounds surround the transition metal oxides by the coordinate covalent bonds to the transition metal oxides.

Referring to the description of the transition metal organic framework described above, the ligands of the organic compounds may form the coordinate covalent bond to the transition metal oxide and the organic brushes having the hydrophilic functional groups, provided at the ends of the ligands, may be disposed toward the outside of the transition metal organic framework. Accordingly, the transition metal organic frameworks may stably exist by forming the hydrogen bonds on the surface of or inside the hydrophilic coating layer.

Accordingly, the hydrophilic coating layer of (b) and (c) of FIG. 3 may include the transition metal organic frameworks that are evenly dispersed, compared to the transition metal oxides in the hydrophilic coating layer of (a) of FIG. 3. Therefore, according to the present disclosure, an effect of suppressing the generation of odor-causing substances can be improved by including the transition metal organic frameworks in the hydrophilic coating layer.

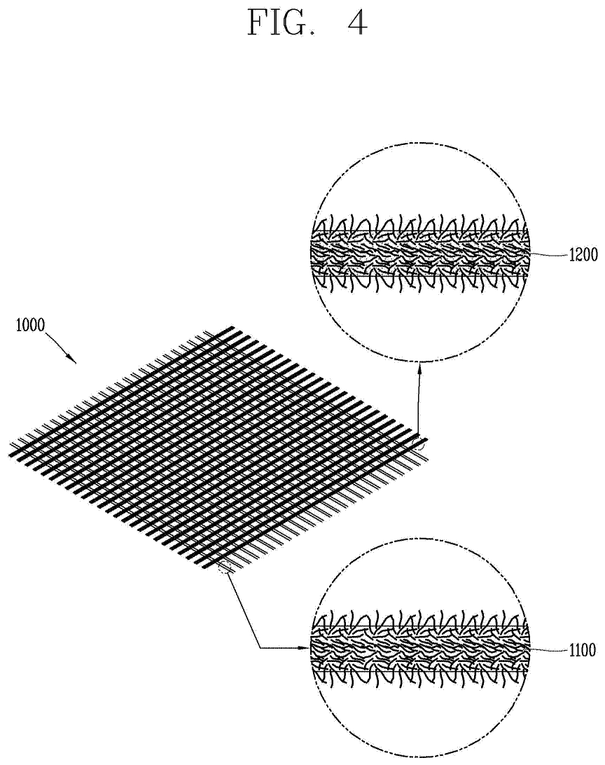

FIG. 4 is a conceptual diagram illustrating a fiber 1000 containing the transition metal organic frameworks according to another implementation.

Referring to FIG. 4, an example of preparing a fiber 1000 containing the transition metal organic frameworks that are mixed in the form of powder during fiber extrusion. The fiber 1000 may include a first fiber 1100 and a second fiber 1200.

The first fiber 1100 may contain first transition metal organic frameworks in the form of powder, and the second fiber 1200 may contain second transition metal organic frameworks in the form of powder. In other words, the first fiber 1100 and the second fiber 1200 may contain transition metal organic frameworks having different compositions from each other, so as to obtain antibacterial effect and antifungal properties against various bacteria and molds. Here, the first transition metal organic framework and the second transition metal organic framework may be any one of the aforementioned transition metal organic frameworks having the different compositions from each other.

Furthermore, the content of the transition metal organic frameworks included in the fiber 1000 may range from 0.5 to 5 wt %. The fiber 1000 containing less than 0.5 wt % of the transition metal organic frameworks may not sufficiently exhibit the antibacterial or antifungal properties due to the low concentration of the transition metal organic frameworks. On the other hand, when the content of the transition metal organic frameworks contained in the fiber 1000 exceeds 5 wt %, miscibility between the polymers mainly forming the fiber 1000 and the transition metal organic frameworks may be deteriorated. Accordingly, there is a problem that the transition metal organic frameworks may be likely to be detached over time due to being incompletely mixed.

In addition, the average size of the transition metal organic frameworks mixed in the fiber 1000 may be in the range of 20 to 150 nm. The sufficient antibacterial or antifungal properties may be exhibited in the average size range of the transition metal organic frameworks. The fiber may be molded without being broken during the fiber extrusion within the average size range of the transition metal organic frameworks.

On the other hand, as the polymers that mainly form the first fiber 1100 and the second fiber 1200, hydrophilic functions groups of the first transition metal organic framework and the second transition metal organic framework in the form of powder may include at least one selected from a group consisting of vinyl alcohol, polyoxyethylene glycol, polysulfonic acid, polyacrylic acid, polymethacrylic acid, and polypropylene glycol.

Furthermore, the fiber 1000 including the transition metal organic frameworks may be applied to a filter, which is one of components constituting an air conditioner and a clothes treatment apparatus, and thus the filter may obtain the antibacterial or antifungal properties, so that the production of odor-causing substances can be prevented.

As described above, the transition metal organic frameworks of the present disclosure may be present in the form of particles in the hydrophilic coating layer and fiber, and thus may exhibit the antibacterial or antifungal properties. Further, in another implementation, the transition metal organic frameworks may be included in an injection-molded product itself, such that the product can have the antibacterial or antifungal properties.

### EXAMPLE 1

### Preparation of Transition Metal Organic Framework

The transition metal organic framework may be prepared by the foregoing description. In detail, the transition metal organic frameworks may be prepared by dissolving α-MoO3 in an aqueous solution of pH 14, and gradually adding 70 wt % of a nitric acid solution containing 20 wt % of terephthalic acid having a carboxyl group (—COOH), and precipitating into the form of particles.

### EXAMPLE2

### Preparation of Transition Metal Organic Framework

The transition metal organic frameworks in which ZnMoO4 is a metal oxide may be prepared by adding and stirring ZnMoO4 powder at a concentration of 10 wt % into an aqueous solution containing 2 wt % of acrylic water-soluble polymer (Synthro W578), stirring the mixture to completely dissolve the powder, mixing ligands, and drying the resultant.

It is apparent to those skilled in the art that the transition metal organic frameworks described above are not limited to the configuration of the above-described embodiments, but may be embodied in other specific forms without departing from the essential features of the present disclosure.

Therefore, it should also be understood that the above-described embodiments are not limited by any of the details of the foregoing description, unless otherwise specified, but rather should be construed broadly within its scope as defined in the appended claims, Therefore, all changes and modifications that fall within the metes and bounds of the claims, or equivalents of such metes and bounds are therefore intended to be embraced by the appended claims.

1. A transition metal organic framework comprising:
a transition metal oxide having antibacterial or antifungal properties; and
an organic compound bound to the transition metal oxide,
wherein the organic compound surrounds the transition metal oxide by forming a coordinate covalent bond to the transition metal oxide,
wherein the organic compound comprises:
ligands forming the coordinate covalent bond to the transition metal oxide; and
organic brushes placed at ends of the ligands, and
wherein the organic brushes each contain a hydrophilic functional group, and the hydrophilic functional group is placed toward outside of the transition metal organic framework.

2. The transition metal organic framework of claim 1, wherein a metal of the transition metal oxide includes at least one selected from a group consisting of W, Mo, La, Ti, Si, Zr, Re, Hf, Ag, Cu, Sn, Nb, Al, and Va.

3. The transition metal organic framework of claim 1, wherein the hydrophilic functional group of the organic brush includes at least one of a carboxyl group (R—COOH), a ketone group (R—CO—R) or an amine group (R—NH₂, R₂—NH, R₃—N, (R—N═R).

4. The transition metal organic framework of claim 3, wherein the organic brush includes cyclic hydrocarbon.

5. The transition metal organic framework of claim 4, wherein the organic brush includes at least one selected from a group consisting of the following structures.

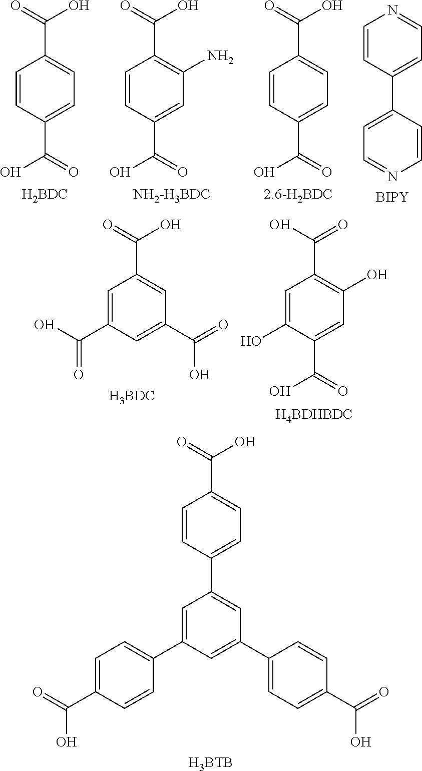

6. The transition metal organic framework of claim 1, wherein a content of the transition metal oxide is 0.1 to 5 wt % of the transition metal organic framework.

7. The transition metal organic framework of claim 1, wherein an average size of the transition metal organic frameworks is 20 to 700 nm.

8. A hydrophilic coating layer comprising the transition metal organic framework of claim 1.

9. The hydrophilic coating layer of claim 8, wherein the hydrophilic coating layer includes at least one selected from a group consisting of polyvinyl alcohol, polyoxyethylene glycol, polysulfonic acid, polyacrylic acid, polymethacrylic acid, and polypropylene glycol.

10. The hydrophilic coating layer of claim 8, wherein an average thickness of the hydrophilic coating layers is 700 to 2000 nm.

11. The hydrophilic coating layer of claim 8, wherein a content of the transition metal organic frameworks is 1 to 5 wt % of the hydrophilic coating layer.

12. A fiber comprising the transition metal organic framework of claim 1.

13. The fiber of claim 12, wherein a content of the transition metal organic frameworks is 0.5 to 5 wt % of the fiber.

14. The fiber of claim 12, wherein an average size of the transition metal organic frameworks is 20 to 150 nm.

15. The fiber of claim 12, wherein the fiber includes at least one selected from a group consisting of polyvinyl alcohol, polyoxyethylene glycol, polysulfonic acid, polyacrylic acid, polymethacrylic acid, and polypropylene glycol.

16. An injection-molded product comprising the transition metal organic framework of claim 1.
